(19) United States
(12) Patent Application Publication
(10) Pub. No.: US 2013/0198094 A1
(43) Pub. Date: Aug. 1, 2013

(54) SYSTEM AND METHOD FOR REGULATION COMPLIANCE

(71) Applicant: Benny Arazy, Misgav (IL)

(72) Inventor: Benny Arazy, Misgav (IL)

(21) Appl. No.: 13/363,734

(22) Filed: Feb. 1, 2012

(51) Int. Cl. G06Q 99/00

(52) U.S. Cl. 705/317

(57) ABSTRACT

The system and method herein disclosed is an online tool for reaching regulatory compliance. It uses a database of requirements by device, country, and agency necessary for licensing and marketing. Further databases include the compliance documents themselves, provided by given users concerning given devices. Still further databases include lists of domain experts, who may be called upon to review and edit these compliance documents. Expert systems running on a server associated with the system and method herein disclosed guide the user along the route to reaching compliance by means of aiding classification, prompting for missing documents, suggesting workarounds, submitting documents and payments automatically, and the like. Regulatory agencies may be given access to parts of the databases of the system and method herein disclosed to allow them to peruse and evaluate the compliance documents.

### BACKGROUND

1. Technical Field

Embodiments of the present system and method relate generally to systems and methods for regulatory approval and compliance, specifically document and procedure management systems.

2. Description of Related Art

The process of receiving a license for a given medical device in any given country is a process that usually consists of several stages including regulatory applications, FDA or equivalent reviews, and the like. These steps will generally be undertaken in each and every country in which a device is to be deployed.

As may be appreciated a large amount of bureaucratic effort is expended on work that is largely redundant. Hence, an improved method for obtaining regulatory compliance and approval is still a long felt need.

### BRIEF SUMMARY

It is within provision of the system and method to disclose a regulatory compliance tool for users seeking to achieve licenses for devices to be licensed by regulatory agencies comprising:
a. a database of regulations concerning a plurality of devices and countries;
b. a database of experts having expertise in matters of regulatory compliance;
c. a database of regulatory compliance documents;
d. an expert system adapted to guide said users along a regulatory compliance route informed by said database of regulations;
e. a server adapted to store said databases and provide communications between said databases, said users, said experts, said expert system, and said agencies;
whereby users can upload and peruse said regulatory compliance documents, experts may review and revise said compliance documents, and regulatory agencies may evaluate said compliance documents, thus implementing a unified compliance tool adapted for use worldwide.

It is further within provision of the system and method herein disclosed wherein the aforementioned devices are selected from the group consisting of: medical devices, therapeutic devices, pharmaceuticals, medicaments, foods.

It is further within provision of the system and method herein disclosed implementing a barcode derived from a hash of said compliance documents at the time of licensing by said regulatory agencies, said barcode adapted to identify said devices to be licensed.

It is further within provision of the system and method herein disclosed wherein said database of regulations comprises continuously updated information regarding regulatory requirements, procedures, and information for each of said devices in each of said countries.

It is further within provision of the system and method herein disclosed wherein said database of experts comprises continuously updated information concerning said experts' domain of expertise, experience, rating, and record.

It is further within provision of the system and method herein disclosed wherein said experts review and edit said regulatory compliance documents.

It is further within provision of the system and method herein disclosed wherein said database of regulatory compliance documents is adapted to be read, written to, and modified by said users, said experts, and said agencies according to a set of permissions determined by said users.

It is further within provision of the system and method herein disclosed wherein said expert system is adapted to assess necessary elements required for said devices to be licensed, and further adapted to guide said users through the process of generating said necessary elements.

It is further within provision of the system and method herein disclosed wherein said server is maintained by system administrators by means of software adapted to allow said system administrators to perform actions upon said databases selected from the group consisting of: adding new devices; adding new device requirements; adding new countries; adding new modules; adding new forms.

It is further within provision of the system and method herein disclosed wherein said databases are rendered easily navigable by means of presenting information contained therein upon a single computer screen.

It is further within provision of the system and method herein disclosed wherein said server is adapted to submit and maintain regulatory applications automatically.

It is within provision of the system and method herein disclosed to disclose a method for achieving regulatory compliance for users' devices to be licensed by regulatory agencies comprising steps of:
a. providing a database of regulations concerning a plurality of devices and countries;
b. providing a database of experts having expertise in matters of regulatory compliance;
c. providing a database of regulatory compliance documents;
d. providing expert system adapted to guide said users along a regulatory compliance route informed by said database of regulations;
e. providing a server adapted to store said databases and provide communications between said databases, said users, said experts, said expert system, and said agencies;
whereby users can follow a stored regulatory compliance route by uploading regulatory compliance documents, experts reviewing and revising said compliance documents, and regulatory agencies evaluating said compliance documents, thus implementing a unified compliance tool adapted for use worldwide.

It is further within provision of the system and method herein disclosed implementing a barcode derived from a hash of said compliance documents at the time of licensing by said regulatory agencies, said barcode adapted to identify said devices to be licensed.

It is further within provision of the system and method herein disclosed wherein said database of regulations comprises continuously updated information regarding regulatory requirements, procedures, and information for each of said devices in each of said countries.

It is further within provision of the system and method herein disclosed wherein said database of experts comprises continuously updated information concerning said experts' domain of expertise, experience, rating, and record.

It is further within provision of the system and method herein disclosed wherein said experts review and edit said regulatory compliance documents.

It is further within provision of the system and method herein disclosed wherein said database of regulatory compliance documents is adapted to be read, written to, and modified by said users, said experts, and said agencies according to a set of permissions determined by said users.

It is further within provision of the system and method herein disclosed wherein said expert system is adapted to assess necessary elements required for said devices to be licensed, and further adapted to guide said users through the process of generating said necessary elements.

It is further within provision of the system and method herein disclosed wherein said server is maintained by system administrators by means of software adapted to allow said system administrators to perform actions upon said databases selected from the group consisting of: adding new devices; adding new device requirements; adding new countries; adding new modules; adding new forms.

It is further within provision of the system and method herein disclosed wherein said databases are rendered easily navigable by means of presenting information contained therein upon a single computer screen.

It is further within provision of the system and method herein disclosed wherein said server is adapted to submit and maintain regulatory applications automatically.

These, additional, and/or other aspects and/or advantages of the present system and method herein disclosed are: set forth in the detailed description which follows; possibly inferable from the detailed description; and/or learnable by practice of the present system and method herein disclosed.

### BRIEF DESCRIPTION OF THE DRAWINGS

In order to understand the system and method herein disclosed and to see how it may be implemented in practice, a plurality of embodiments will now be described, by way of non-limiting example only, with reference to the accompanying drawings, in which:

FIG. 1 illustrates a block diagram of the system and method herein disclosed;

FIG. 2 illustrates a set of block diagram element details;

FIG. 3 illustrates a set of block diagram element details;

FIG. 4 illustrates a set of block diagram element details;

FIG. 5 illustrates a further block diagram of the system and method herein disclosed;

FIG. 6,7 illustrate an FDA 510K compliance document;

FIG. 8 illustrates the table of contents of a compliance document;

FIG. 9 illustrates a warning label for a medical device;

FIG. 10 illustrates a gamma radiation testing document for a medical device;

FIG. 11 illustrates a compliance classification document for a medical device;

FIG. 12 illustrates an example of a GUI of the system of the system and method herein disclosed adapted for perusing documents;

FIG. 13 illustrates an example of a GUI of the system of the system and method herein disclosed adapted for uploading documents;

FIG. 14 illustrates an example of a flowchart for a client applying for a new application;

FIG. 15 illustrates an example of a flowchart for an expert viewing an application;

FIG. 16 illustrates an example of a flowchart for an admin adding a new product requirement.

### DETAILED DESCRIPTION

The following description is provided, alongside all chapters of the present system and method, so as to enable any person skilled in the art to make use of said system and method and sets forth the best modes contemplated by the inventor of carrying out this system and method. Various modifications, however, will remain apparent to those skilled in the art, since the generic principles of the present system and method have been defined specifically to provide a means and method for providing a system and method for regulatory compliance.

In the following detailed description, numerous specific details are set forth in order to provide a thorough understanding of embodiments of the present system and method. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the system and method herein disclosed.

The term ‘plurality’ refers hereinafter to any positive integer (e.g, 1, 5, or 10).

The system and method herein disclosed comprises an expert engine adapted for intelligent execution of regulatory application management algorithms. Some embodiments are special cases of more general engines providing solutions for the medical and In vitro diagnostic (IVD) device industry.

The process of receiving a marketing license for a given medical device in any given country is a process that usually consists of the following stages:

a. Determining the required Compliance route

b. Performing product compliance

c. Preparing local Regulatory Application

d. Local FDA (or equivalent) review

e. Receive approval/failure

f. Start from the beginning for next market

The profession responsible for the collection of information, planning and execution of the above activities, including all steps involved in obtaining the marketing license is called “Regulatory Affairs”.

Currently the overall global process for the regulation of medical and IVD devices is fragmented, costly and time consuming for the following reasons:
1) Difficulty determining the compliance route. The compliance route is different in each country, based on internal regulations, laws, and criteria related to what is known as the ‘Risk Class’ assigned to each type of medical & IVD device (there being well over 400,000 types known to date). From a global perspective this route is fragmented, inconsistent, obscure, convoluted, obfuscatory, and subject to arbitrary and interminable changes and modifications, constituting an ever-shifting path through a dense regulatory jungle. The information required in attaining compliance is divided into several categories according to the type of manufacturer, the safety attributes of the device, the clinical efficacy of its use, the domestic import and distribution laws, license rights, language, and legal issues. Furthermore, ongoing maintenance activities, reporting and related fees required to sustain the license validity postpone its acceptance. In most cased the medical and IVD device manufacturer is required to source a regulatory expert in each market, or rely on the services and knowledge of a local distributor to provide him with the information and guide him through the process.
2) Difficulty performing product compliance. Based on the information provided the manufacturer R&D and Engineering department will engage in a process that is known as Verification and Validation, wherein the device quality and performance will be tested in order to meet the requirements of each FDA or analogous agency in the intended market. Because of the limitations inherent in gaining a complete, up-to-date view of the global requirements for licensing in a given country, most manufacturers will adhere to the requirements of the domestic market and one or two of the more significant markets, which traditionally have been the USA, EU and Japan. The correct information still needs to be gathered pertaining to the device compliance route and the specific verification and validation criteria which need to be tested and proven successfully with the local FDA (or equivalent agency) requirements.
3) Problems preparing local Regulatory Applications. Every FDA or equivalent agency in each country has their own requirements as to the type of information they would like to receive, the order of things they would like to be presented, the form in which the information is to be presented, etc. Some manufacturers/distributors will simply adhere to procedures successfully followed in obtaining regulatory licenses in the country of origin or other leading markets (US, EU, Japan Canada and Australia, to name a few), foregoing the attempt to obtain license elsewhere due to the complexity of the task as outlined above. Many manufacturers/distributors do not have a clear or well defined regulatory law or licensing process, and will review each device on a case by case basis. Often regulatory professionals for the manufacturer will depend entirely on a local distributor or regulatory expert to present them with the documentation and other forms of information required, without any control over their use or the product registration process in that market. Furthermore in most cases the regulatory professional will not be in contact with the local FDA or equivalent agency, and will not be able to intervene in or influence the process. Another aspect that further complicates the process is that the manufacturer is legally bound by numerous national laws, must operate in multiple languages, trade in many currencies, etc.
4) Local FDA Review. Application review can take many different shapes and forms. Some FDA agencies will find it sufficient to perform a desk review of the document presented to them, while others will require an on-site visit at the manufacturer's facilities, either by their own personnel or accredited third parties. The total review time also differs from one agency to the other, and the review is often performed by one single reviewer. This introduces a personal factor to the process based on the reviewer education, knowhow, experience, seniority, and interaction with the manufacturer/distributor. In many countries this is considered a critical factor that will determine the outcome of the application. Due to the fact that many of these local applications are performed by the importer or the distributor, the ownership of the license remains with the importer or distributor.
5) Repetition. The need to repeat the entire aforementioned process for each and every type of medical device, in each and every country in the world, for the purpose of global sales and distribution is costly, time consuming, and in many cases unnecessarily inefficient.

The system and method herein disclosed comprises an intelligent regulatory application management system which maintains databases of regulations, experts, and individual applications, and moreover executes in part or full many of the details required in existing practice of regulatory compliance, guiding the applicant through stages it cannot perform independently. The method simplifies and unifies many of the processes involved in licensing, provides computerized information, lookup, tracking, and guidelines for many of the activities, and maintains up-to-date information integrity. The system comprises several novelties that have not been in practice until today as will be detailed below.

The system comprises a “Creative Expert Engine” (CEE) of which a specific category may take the form of “Intelligent Application Management” (AIM), a special case of CEE adapted for executing intelligent regulatory application management in the field of medical and IVD device global regulations.

The major properties of the system comprise:
a. an updated database of the complete device compliance requirements for each country, including risk class and device type.
b. an updated database of compete regulatory application requirements (compliance route) for each country including risk class and device type.
c. an updated database for the complete country specific related requirements.
d. an updated database of the generic master regulatory file for each type of medical device for each country.
e. a platform for upload, review, and download of documents and exchange of information between user, experts and auditors. (This may include an implementation of “Document Control”)
f. an updated database of a master regulatory file for any single client product. The file includes the complete product/client/country information that is required for the preparation of a license application in a given country.
g. an application generator for each compliance route in each country that can be applied to any one type of medical or IVD device. The application follows up and integrates resources required for the successful registration of the product in a country. The application is generally accessible to manufacturer, consultants, regulatory agencies and third party certification bodies anywhere and at any time, license permitting. The application is available standalone, or as a cloud web based application. The latter option of course allows global access (to those with the proper permissions) such that for example a pharmaceutical manager in Jerusalem can upload laboratory results that a licensing manager in Hyderabad can use in his licensing route.

The system and method herein disclosed utilizes an intuitive service for the manufacturer of medical devices seeking to register a product in as many countries as desired in a comprehensive, cost effective and rapid process. This service can be delivered at any time and can be accessed from any given place, at single or multiple country level, providing anything from a full set of regulatory applications in a number of countries to simply the review of a single document. The system guides the applicant through the complete process, obtaining from the applicant the relevant information, and suggesting professional and practical solutions when information is lacking and/or missing. The system takes full control and responsibility for the application preparation process and the submission of the regulatory file in each country while providing up to date status as to the progress of the application and license approval.

Below is a short flow chart for one embodiment of the process.

Application Preparation Process
a. Client chooses the “Type of medical device”
b. Client chooses the “Country(ies) for registration”.
c. The system provides a list of all necessary documents for that country, or countries.
d. Client uploads documents and information into the system.
e. The system validates document and information integrity, and suggests modifications. The former may be accomplished by means known in the art; for example a database may contain information such as business names, addresses, contact information, device classification and the like. Field recognition as known from such techniques as ‘auto fill’ (common in today's web browsers) can then be used to verify correctness of information, or for auto-fill of these entries. The latter (suggesting modifications) can be carried out when a discrepancy is found between entered information (for example a misspelled correspondence address) and database information (the actual correspondence address).
f. The system prepares the regulatory application(s). Again this may be accomplished to some degree by means of autofill techniques. Certain required fields will reoccur in a variety of forms necessary for regulatory approval; the same information for instance will occur on multiple forms at different stages and in different countries such as contact information, device category(ies), device description, current approval level(s), and the like. Since this information is stored in appropriately identified fields in a database, they may be used for preparing applications by automatically filling the appropriate locations of various forms. Any fields that remain unrecognized may be flagged by the system and thus brought to the attention of the applicants.
g. The system provides all complementary services. This includes for example preparation of auxiliary forms, preparation of form letters and cover letters to be sent to various official factors (which again may be accomplished by use of boilerplate text stored in a database), collation of various documents, and the like.
h. The system submits the regulatory application or multiple country applications. This may be accomplished by use of email addresses of various governmental, regulatory and other agencies in the database of the system. Upon approval of the applicant (pending optional review of the documents prepared by the system), the system sends the relevant documents required for a given regulatory step to the relevant addresses, either by means of the email addresses mentioned or by printing hardcopy.
i. Client is notified when license is achieved. This will occur for instance by means of monitoring email for certain form letters sent when a given approval is met; for instance when the USPTO approves an electronically submitted provisional patent application a certain standard form letter is sent to an email address associated with the application. This form letter due to its standard nature may be recognized by the system automatically and further steps may be taken thereupon for instance changing a status field associated with the relevant device, from ‘pending’ to ‘approved’.
j. The system maintains license validity and updated regulatory status. This can be accomplished for instance by sending appropriate elements at appropriate times such as continuation forms, fee submissions, renewal forms, and the like.
k. System (and client if necessary) repeats steps above for additional markets.
l. The system employs an expert system to advise the client on accessing other markets based on product information integrity, time to market and stated budget as will be explained below.

### Services

The client will be able to choose a variety of services for each country and relevant document of interest. Such services can take the form of the following flow list, which are steps/choices taken by the applicant:
a) Choosing documents for review:
   i) single form/document
   ii) selected several forms/documents
   iii) single or multiple Risk Modules
   iv) complete application, or
   v) no review, in which case the user simply wishes the system to take the document at face value and just make the necessary application filing.
b) Review level:
   i) document integrity, or
   ii) professional content review
   A document can be examined on a superficial level to make sure it is the type of document required and it contains the right sections of information required (administrative review), or it can be examined for its content (for example comprising professional review by an expert).
c) Professional consultation, review, or preparation of test reports and documents:
   The system will offer the client various level of expert service based on the findings of documents reviewed, ranging from an ad-hoc consultation to actually preparing the document from start to finish for the client.
d) Number of people to review the document:
   i) Multiple reviewers, or
   ii) single reviewer.
   Seeking more than one “second opinion” may be especially important where the user wants to establish both integrity, accuracy and quality of the data presented in the document, building an unbiased professional rating of the document and the data it concerns. Because the system is connected to so many experts, there can be multiple reviews of any single document by any number of them, for example according to seniority or other criteria.

Upon gathering this information from the applicant, the system will then take further steps, either unilaterally, or upon approval of the applicant:
e) Preparation of regulatory application. Following the upload and the review of the documentation, users may instruct the system to go ahead with the preparation of the different countries' applications. This can be accomplished for example by means detailed above under ‘Application preparation process’.
f) Submission of applications. As noted above users may instruct the system to take the steps of making the application submission to the authorities and following it through until a license is obtained, or may perform one or more of these operations manually.
g) Complementary services of any kind which are part of the application requirement for any type of product in any country may be performed by the system where possible. For example, local authorized Representative or License holders can be retrieved from databases of the system when required or advisable, and correspondence or other actions may be initiated therewith; legalization services of documents may be performed (for example by means of sending a document with appropriate automatically generated cover letter to a notary also listed in a database of the system), translations may be made (for example by sending documents to be translated automatically to translators associated with the system and whose names are kept in databases of the system), and so on.
h) Ongoing maintenance services. As mentioned above these include annual renewal form submissions, updating device changes in various forms, and updating new regulation requirements into the device application. This latter may require human intervention; for example when a given regulation is changed in law or otherwise, a human administrator of the system may be required to manually changed the system operation to reflect the change in the law or other requirement. For example if a new form is required in a given country for a given device class, the system administrator must append the list of required documents listed in the database entry for that device class and country. An example of the blank document may then be entered in a database of documents, and the various fields of the document may be assigned matches in the database of the system. For instance a document requiring device name, EU classification, description, and current status in various fields, may have these fields marked as corresponding to the appropriate system fields. This can be accomplished even for scanned documents that have not undergone OCR; the admin simply needs to indicate field locations on the document and identify them to the system (for instance by means of a dropdown listing of all possible database entries). Then the system can fill out this document automatically for any application to which it is applicable, by retrieving the appropriate database entries.

### Intelligent Wizard.

It is within provision of the system to provide regulatory intelligence pertaining to the maturity of the client's product information which can be used for various purposes. The reader will note that this has not been previously possible.

The system is adapted to deliver clear answers as to where the client can obtain additional product sales licenses, based on several parameters such as currently achieved licenses, time required to obtaining the license, cost to attain licenses, license budget, and the like. Such information can establish a whole new paradigm replacing the current practice in the field of medical devices, wherein regulatory activities can now precede marketing activities, influencing company and product value by making the device “Marketable” in various markets.

It is within provision of the system and method herein disclosed that it advise users concerning modifications and amendments that need to be taken into consideration when designing a new product, advising for example implementing changes in existing products and products under development.

### Work Place/Environment

The following are characteristics consistent with embodiments of the system and method herein disclosed:
a) Accessibility: The system may be accessible to all. This includes manufacturers, regulatory professionals, professional engineers, government agencies and third party reviewers. The access to a given file by anyone other than the legal owner of the information (i.e the manufacturer) is subject to assigned permission levels determined by the legal owner of the information, at the single document, folder, product, and product line levels.
b) Qualification of processes by domain experts: an expert may be assigned to fulfill any singular requirements based on their level of expertise and experience once qualified. Each expert is continuously rated by other experts as well as FDA agency reviewers when reviewing the same records.
c) International virtual working platform: Any expert in a field of science, engineering, clinical, testing, regulation etc., can join the system as a domain expert and offer his services. Review processes of single documents, a complete module or an application, as well as consultation services offered to the client when such are needed and or requested may all be offered. A job is offered and “pushed” around the clock to the selected experts.
d) Experts: Any person with the relevant background and education may qualify, regardless of origin, current location, or other extraneous factors.
e) Income sharing: based only on their “Expert Level”. As part of the concept of “Globalization of individual income”, regardless of expert location, the rates will be identical, and may be paid in any currency.
f) Computerized promotion system based on historical performance and overall peer ratings.
g) Career Singularity: enable a person to develop a career around a specific niche of knowledge independent of other disciplines and or capabilities. This is in keeping with the globalization of individual expertise.
h) A true virtual, green, zero emission working space based on telecommuting, saving fuel, vehicle costs, time, and infrastructure capacity.
i) Direct access between the manufacturer engineer and the regulatory system, at each stage of product R&D or manufacturing.

### Document and Form Review:

The following list details some characteristics of the documents and forms and their treatment under auspices of certain embodiments consistent with the system and method herein disclosed.
a) Document and version control of single documents, forms and notes as well as the final submission file are kept throughout the process. An archive of files and folders may be kept for a minimum duration, for example 7 years, or such duration as required by the authorities in any given territory. The database may be internet cloud based and hence, universally accessible to those having proper permissions.
b) Professional uniqueness: the system is adapted to select the most appropriate reviewer(s) based on each experts' “unique qualification indicator” (UQI). This indicator is a metric determined by the system and adapted to guarantee the choice of the most appropriate professional expert designated to the review of that document or form.
c) Non Bias/conflict of interest: Since every form/document review is performed by unbiased professional experts independently of other elements of the complete regulatory file, the integrity of the documents and the data presented are free of all bias or conflicts of interest that are known to arise when one single reviewer or regulatory professional reviews/presents a file to the authorities. The process is hermetic and compartmentalized, which also eliminates certain risks concerning information security as will be clear to one skilled in the art.
d) Document quality ratings: Every reviewer will indicate a quality rating for each document, form, and file when its review is completed. This will create a rating of each document which can be considered by any agency reviewer when investigation a license application that will be submitted for its approval.
e) Multiple reviews by multiple experts: Each form/document can be reviewed by several independent experts, thus creating another higher level of quality, integrity, and accuracy as to the data presented in it.

f) Global FDA agency records—the system maintains records concerning each review of a client/product file.

An example of a matrix of UQI values as referred to in step b) above is given here; in this example the values are integers on a scale of 0-100.

| | Laser | Laser | Laser |
|---|---|---|---|
| | Angioplasty | Angioplasty | Angioplasty |
| | Approvals - | Approvals - | Approvals - |
| Expert Name | French | German | English |
| Jacques LeFabre | 90 | 60 | 10 |
| Heinreich Hornmutter | 80 | 95 | 70 |
| John Forbles | 0 | 0 | 80 |

Thus in this example three experts in Laser angioplasty regulation have high UQI values concerning documents in their native languages, and lower values in non-native languages depending upon their proficiency and experience in those languages.

### FDA Agency Review and Licensing Process.

The system and method herein disclosed furthermore provides means and methods for regulatory agencies to deal with medical device applications for license. The following is a brief review of the process involved and the provisions of the system relevant thereto.
a) Breakdown of the compliance route: using the system each agency (regulatory or otherwise) can decide what type of document and data it requires for each single product, by risk class or by type of device.
b) Removing the burden from the reviewer: since product validation and verification information will be reviewed by a number of qualified independent experts, (whose qualifications and other records the agency can access at any given time), the agency reviewer can concentrate on determining if the overall information provided by the various records presents sufficient evidence for the safety (or other compliance) of the device, rather than requiring the agency reviewer to have expertise on all subjects pertaining to the device risk analysis (or other requirements).
c) Any product file/client will be rated following each review by any necessary additional regulatory agencies or bodies.
d) A rating system of agency reviewers and performance is implemented
e) Multiple agency reviewers and experts may peruse a single application simultaneously and asynchronously, using the same unified system and modalities.
f) Easy access for change and modification of a single requirement, device classification, or a complete compliance route.
g) Reduction of agency cost of operations
h) A platform for vigilance reporting concerning various databases associated with the system, as well as any other post-marketing feedback (such as would be available to FDA or equivalent agencies)

### System Specification Including User Interface

The follow non-comprehensive list details some possible elements of a user interface consistent with certain embodiments of the system and method herein disclosed.
Risk Modules
Compliance forms under each module
Cross references of compliance forms with international and domestic markets
Cross references of compliance forms with expert data base and database of expertise at the singular requirement level
Data entry and maintenance interface
User interface—Portal
Expert interface
   Expert's assignment. Experts are located and integrated into the system through an expert profile and assignment matrix which correlates between experts and the type of modules and devices that he/she is qualified for. As mentioned above in the section ‘Document and form review’, a rating may be assigned for each expert regarding each document or form. As will be appreciated such a table or matrix of values (i.e. a vector of values for each professional) allows the system (or human user thereof) to select the most appropriate reviewer(s) based on each experts' qualification (referred to as the expert's “unique qualification indicator” (UQI)), this indicator again being a metric adapted to guarantee the choice of the most appropriate professional expert designated to the review of that document or form.
   The expert chosen (for example by the above UQI, or manually) reviews documents/requirements under his/her responsibility and approves or comments upon them through the client portal, which enables communication with the client. This communication is maintained using version and document control until the document achieves the maturity level required to reach its final version and enter the client master file.
Application interface
FDA agency/third party review interface
Report and intelligence
Payment transfer interface
Client account profile
   Client pre-set information: Device, trade names, GMDN Code etc.
   Client service profile
   Clients contact expert profile.
Expert account profile
   By product
   By module
   By standard
   By compliance form
FDA agency profile

### System Logic and Flow of Information

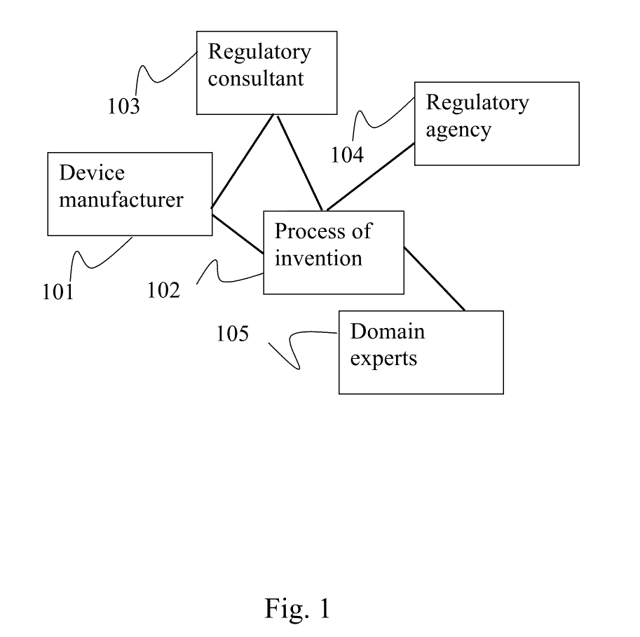

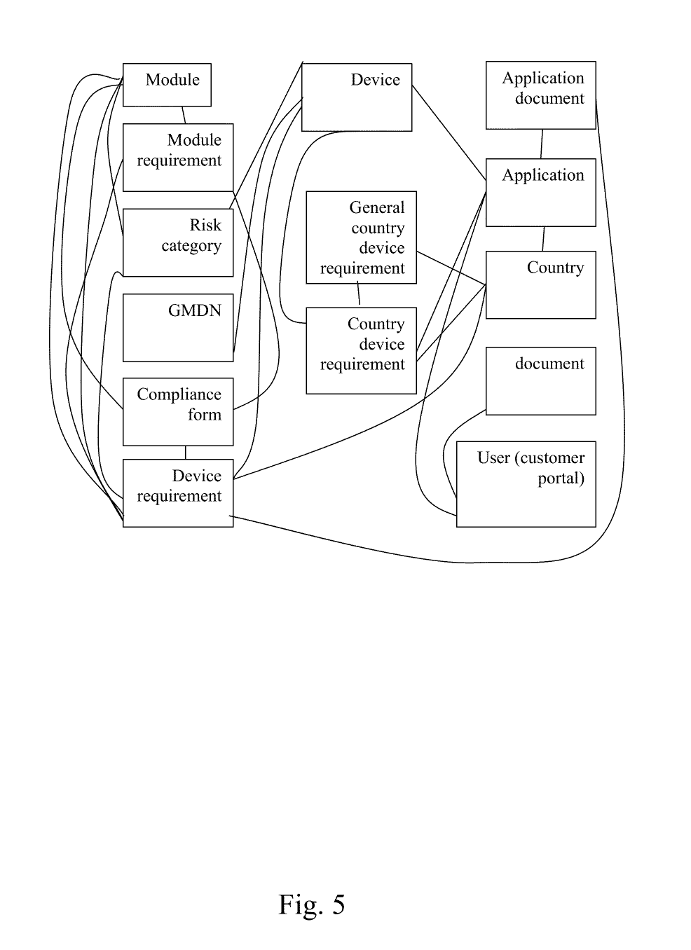

The system logic is detailed in part in FIGS. 1 and 5. FIG. 1 presents a schematic block diagram of one aspect of the system and method herein disclosed. The device manufacturer 101 is in communication with the regulatory consultant 103, which are both in communication with the process 102. Likewise domain expert 105 and regulatory agency 104 are in contact with the process 102 (for instance by means of algorithms running on one or more net-connected servers).

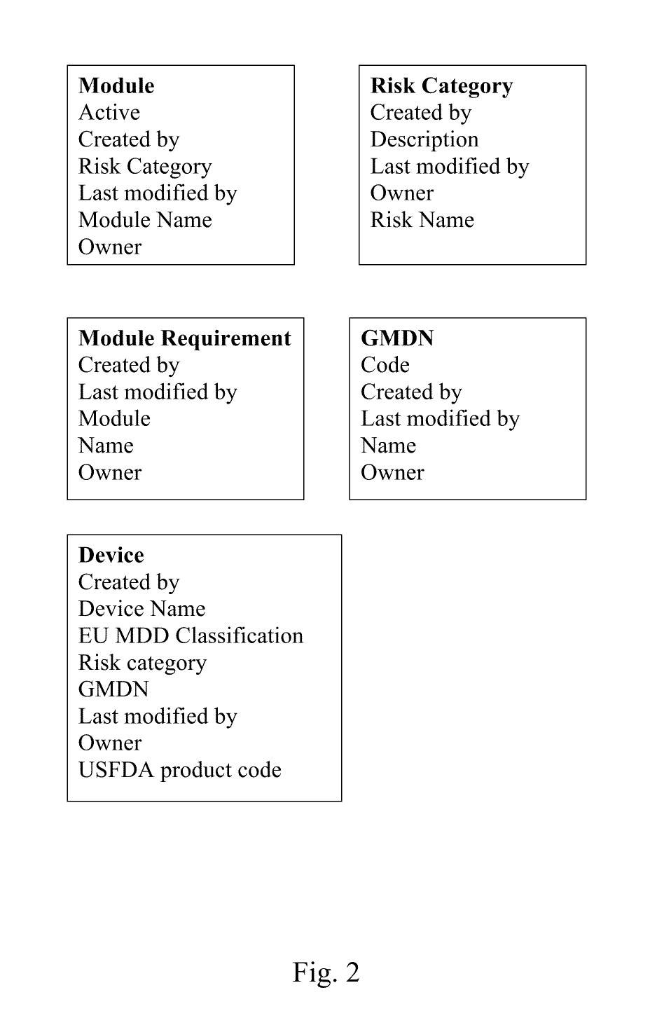

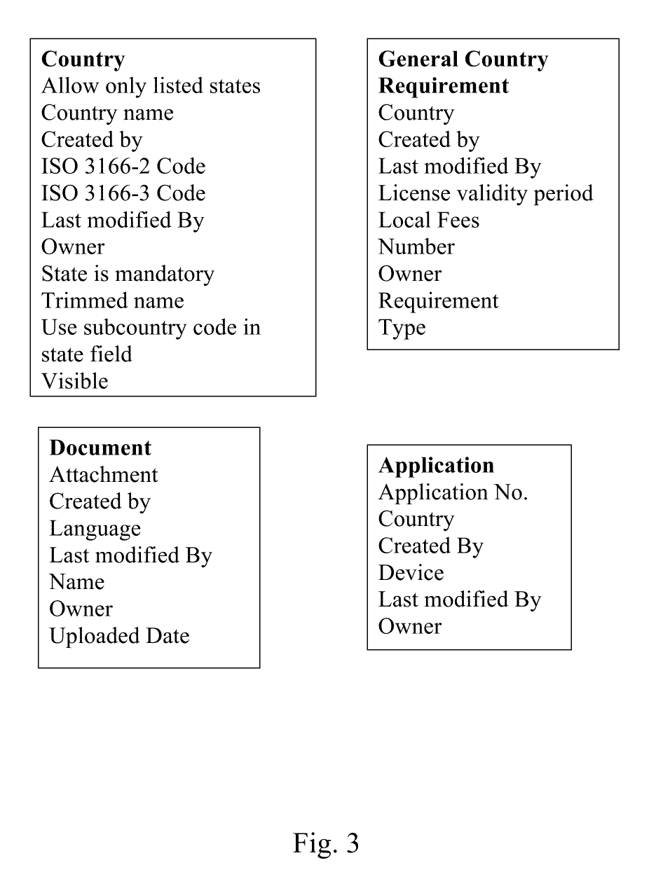

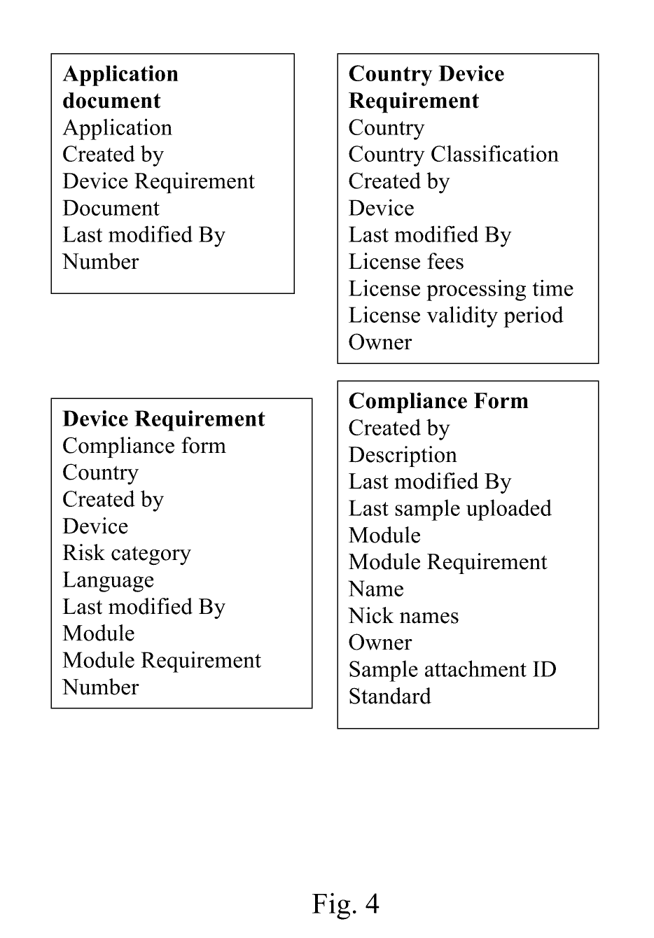

In FIG. 5 the basic software building blocks of the system are connected logically in a system diagram consistent with one embodiment of the system and method herein disclosed. Thirteen basic blocks are used, namely the module, risk category, module requirement, GMDN, device, country, general country requirement, document, application, application document, device requirement, country device requirement, and compliance form, (see FIGS. 2-4 for details). These are linked with respect to their functions and/or data as represented by a block diagram of FIG. 5. The blocks may be thought of as objects (for instance in an object oriented programming context), and are listed and briefly explained below:
a. module—a class of device (for example, ‘laser angioplasty device’)
b. risk category (the FDA for example has a three-level risk category scheme, Canada and the EU have four-level schemes, and the like. Thus risk category may be implemented as a multi-valued object having entries for each country.)
c. module requirement—this is a particular requirement for a given module, for example “General Controls”, “Special Controls”, “Premarket Clearance” and “Good manufacturing” are all requirements for laser angioplasty devices.
d. GMDN (Global Medical Device Nomenclature—a universal classification system for medical devices for example a centrifuge may be coded as follows:
   Term: Centrifuge, general-purpose laboratory
   Code: 36465
   Definition: A device that is a general-purpose laboratory centrifuge used to separate the components of suspensions by the application of centrifugal force. It typically consists of an electrically-powered drive unit with a vertical shaft and horizontal rotor attached to the upper end. This device is intended to centrifuge patient samples, e.g. body fluids, either alone or after addition of reagents or other additives before measuring analytes. It is typically a low-speed (up to 6000 revolutions per minute (rpm)) or medium speed (up to 12000 rpm) machine.
e. device—this is a particular device name
f. country—country name and associated information such as ISO codes, whether it is mandatory for a given device, and the like.
g. general country requirement—nonspecific requirements for regulatory approval in a given country including local fees, license validity period, and the like.
h. document—a block intended to allow the system to track particular documents, including the document path, language, name, and other associated details.
i. application—a block encoding particular application information, including the application number, country, and other associated details.
j. application document—a sub-block of the application block, comprising information concerning a particular document associated with an application including the associated application, device requirements, and the like.
k. device requirement—comprises information relevant for achieving compliance in a given country including a particular compliance form, country, device, risk category, language, module, and the like.
l. country device requirement—comprises information concerning a specific countries' requirements for a given device, including the country name, classification, device name, license fees, license processing time, validity period, and the like.
m. compliance form—this is a block comprising information about sample compliance forms, including references to samples, sample attachment IDs, associated standards, and the like.

Unique Elements of the System:

A unique product classification code (hereinafter referred to as GPCC) is used for each product of the system, which may comprises a document, series of documents, compliance route, device, system operation, or the like. This code is derived by computation of all of the parameters pertaining to any one type of device. The code relates to the device and associated keywords which allow users of the system to easily search, locate and browse a larger group of devices.

A unique Product Compliance Form Code (hereinafter referred to as GPCFC) is similarly obtained by computation of a Product/module/compliance form/standard/country value.

A unique client/device indicator (hereinafter referred to as UCDI) is delivered by collecting and integrating all of a specific client's GPCFCs into one string that represents a “Client/product record” in the system. This string is also presented by in a form of a barcode which can be used to retrieve the “Client/product record” or deliver such record to reviewers and authorities. This code can also take place as part of the product labeling.

An expert unique qualification indicator—(EQI) is furthermore provided. When information associated with experts is introduced into the system, the fields correspond to those used for the GPCFC/ In this way a document or other file within any specific GPCFC can be directed for review and comments by the most qualified expert on a singular level.

### Details of System Operation

A regulatory file is generally speaking a composition of documents that address various risks that are derived from a risk analysis of the device, its technology and its intended use. These risks are divided into categories hereinafter referred to as Modules. These categories comprise for example: electrical safety, biocompatibility, packaging, sterility and disinfection, software validation, clinical evidence, etc. The content of these modules are documents validating and verifying these risks, usually in line with international relevant standards that show that the device function within that module is risk free, or lies within the acceptable range of risk for the application. Such documents may comprise test reports, descriptive documents such as the “labeling and instruction for use” text, summaries of clinical studies, literature reviews of the field, etc.

Document validation can occur in several ways. It may be performed by human intervention, or automatically. Documents are coded by the system and then they are directed to independent experts whose knowhow and experience is coded in the same manner, thus providing optimized matches between the independent experts and the revised document. The successive revision of the documents is accomplished by means of a dedicated customer portal to which every client has access.

The compliance services are professional services that often cannot be automated and require expert human intervention. However since there are hundreds if not thousands of experts registered with the system, such services will be available and accessible in a nearly instant and world-spanning fashion. Thus companies will not require external professional review, but rather may simply use the system as ‘black box’ that generates valid, expert-level documents. It is this process (ie. the communications between the ‘black box’ to the user) that can in fact be automated, entirely or largely.

Some of the activities involved in the regulatory compliance process can be automated, such as registration, re-registration, renewal of service, payment, and the like. Other processes and sub-processes may be semi-automated, such as the introduction of new standards by a given regulatory authority, which for instance may trigger an immediate requirement for updated information from all manufacturers whose products are influence by the change.

It is within provision of the system and method herein disclosed that one may query the system in a form that cannot be addressed attempted without it. For example, a given manufacturer may formulate the following question: “Based on my current level of compliance, what are the additional markets my product can get access to over the next 4 months for a budget equal or less than $10,000?”. Due to the various databases of the system described above, the system will be able to correlate, index, and cross-reference between knowledge and requirements in order to answer such queries quickly and correctly. No such method currently is provided, causing a degree of uncertainty, confusion, and unnecessary ‘hand labor’ for industries faced with such problems. Furthermore it is within provision of the system and method herein disclosed that the system be able to “push” recommendations to the client concerning the next action(s) he/she should take in order to (for instance) increase market penetration. As an example take for instance the requirements concerning maximum laser power in a laser angioplasty device. The system has on file information concerning the device including documents certifying the laser power. This information is entered into a database of the system for instance in the form of a field specifying device laser power (or a power spectrum, or the like). Given this known and documented laser power, specifications concerning maximum laser power may be met in various regulatory applications, by use of the known laser power and supporting documents if necessary. In this way matches between regulatory requirements (for maximum laser power in this example) and knowledge (of actual device laser power in this example) are correlated.

Furthermore the client will be able to determine in real time the current stage of his/her product registration process, in every part of the globe and at any hour.

FIG. 1 presents a schematic block diagram of one aspect of the system and method herein disclosed. The device manufacturer 101 is in communication with the regulatory consultant 103, which are both in communication with the process 102. Likewise domain expert 105 and regulatory agency 104 are in contact with the process 102 (for instance by means of algorithms running on one or more net-connected servers)

FIGS. 2,3,4 present a set of characteristics associated with each of a set of entities associated with the operation of the system and method herein disclosed. In FIG. 5 these entities are connected logically in a system diagram consistent with one embodiment of the system and method herein disclosed.

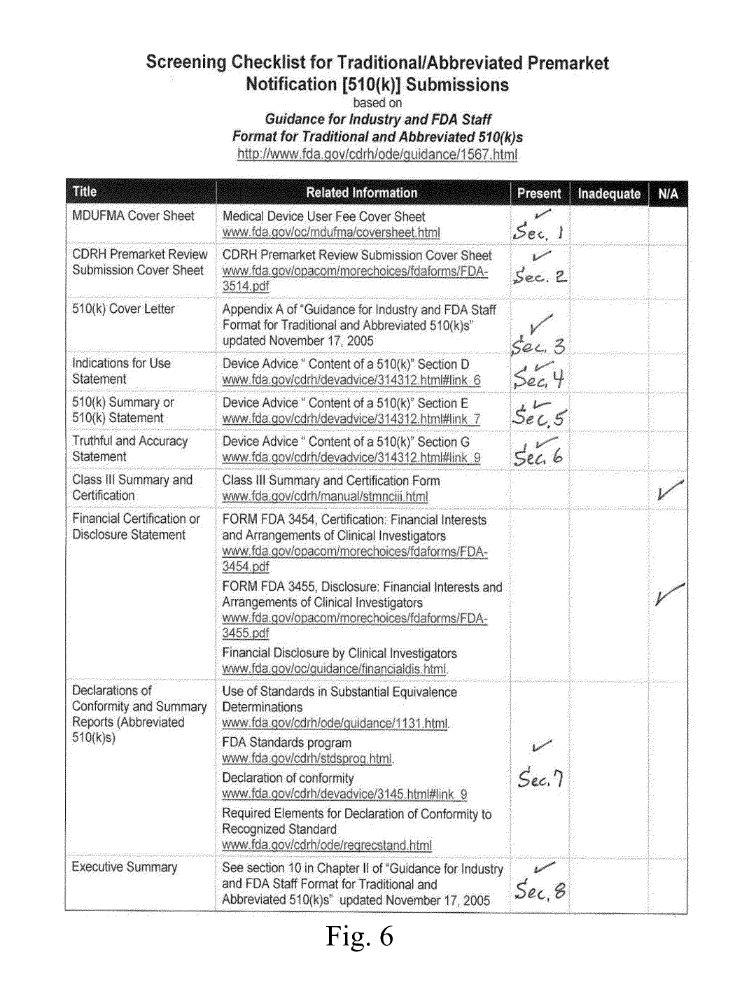

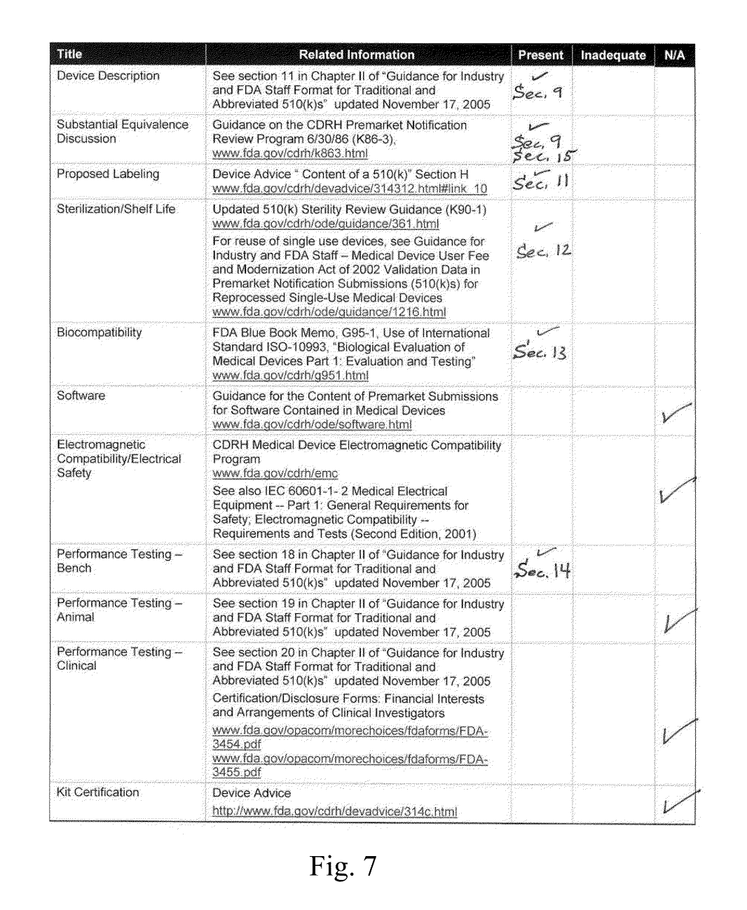

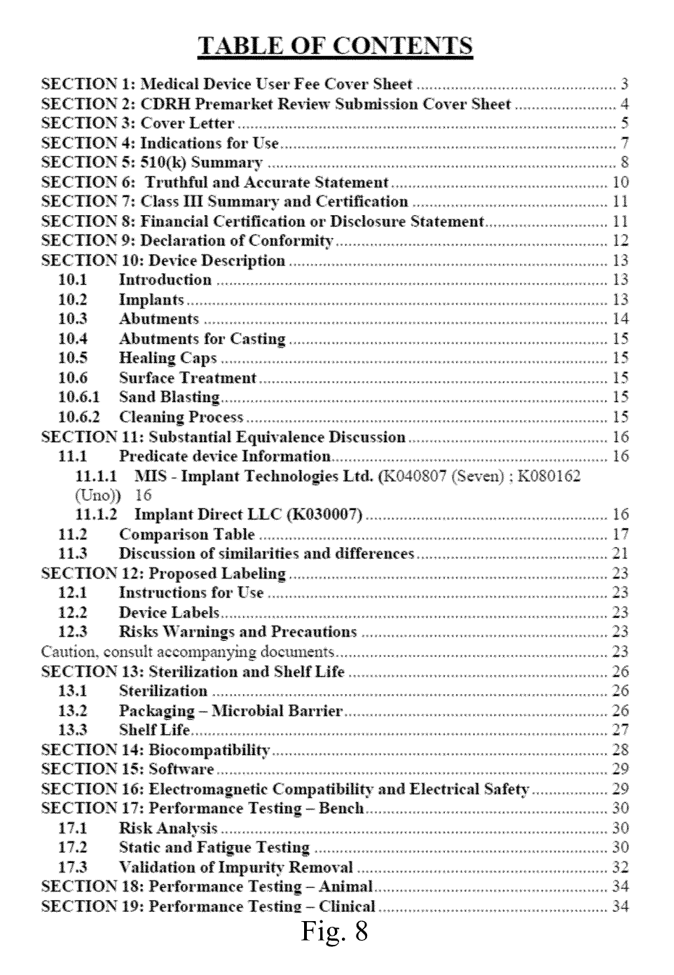

FIG. 6,7 presents pages from an FDA 510K check list, of the content of such file. FIG. 8 depicts a table of contents for a regulatory compliance document, illustrating the sheer number of sub-documents that must be submitted in any given stage of a compliance route.

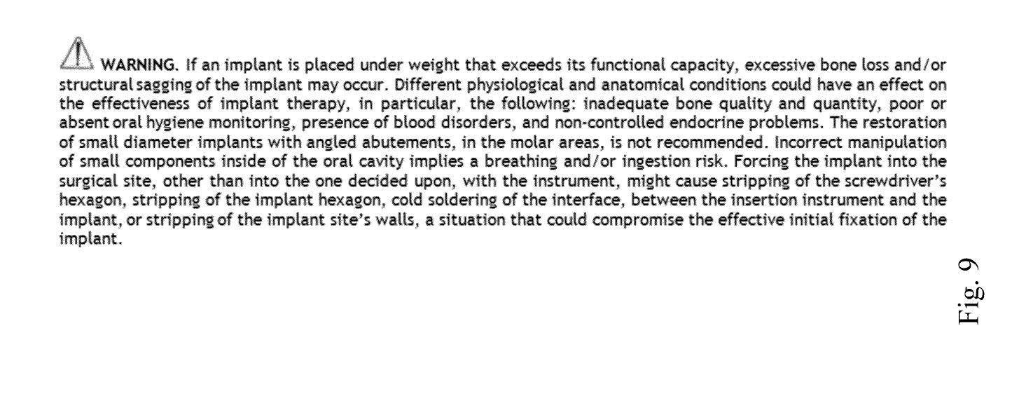

FIG. 9 depicts a warning sign for an implant, of the sort that a manufacturer must supply and have approved in any given jurisdiction in which it desires to market a medical device.

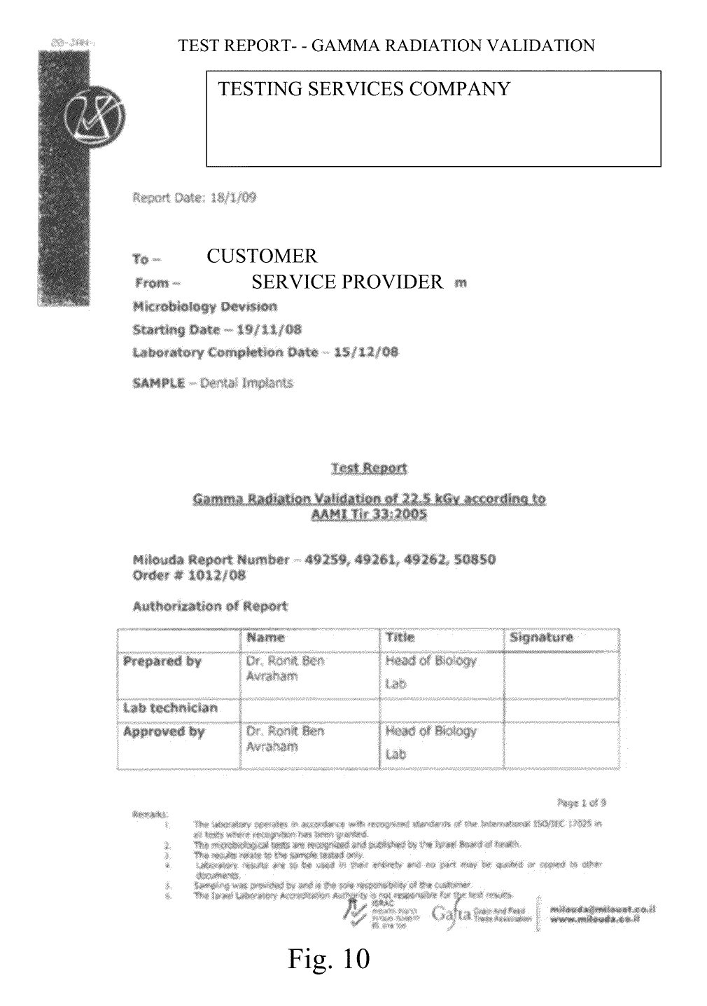

FIG. 10 illustrates an example of a compliance document. In this case the document attests to testing for gamma radiation validation of a certain device. This kind of validation is just one of many types of supporting document that must be supplied in an attempt to license and market a medical device.

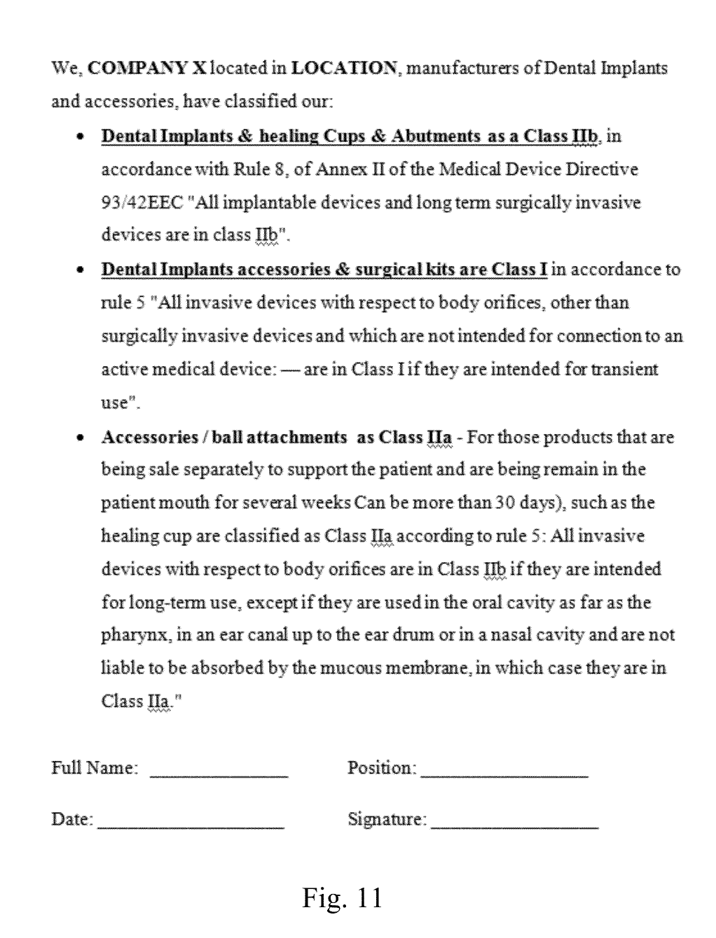

FIG. 11 illustrates another document that a company might have to supply in its quest for regulatory compliance. The document describes the classification(s) of the device in question in an attempt to define these classes for purposes of further compliance procedures.

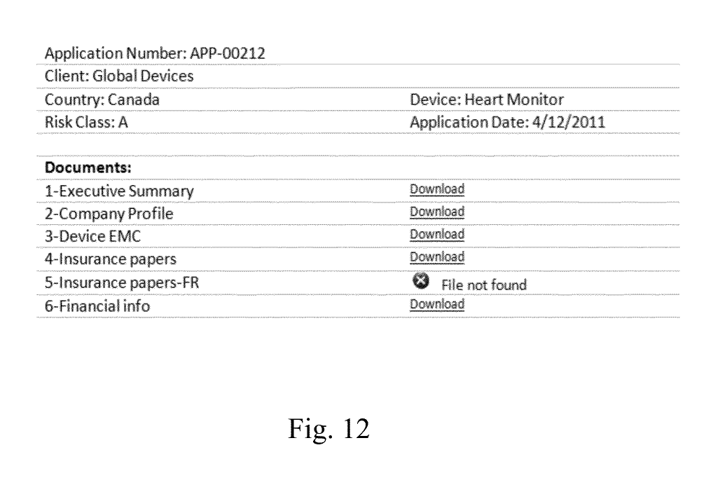

FIG. 12 presents one possible element of the UI of the system, in particular a page of details concerning a certain application. Thus the application number is listed as well as related information such as client name, country, risk class, device name, and application date. Furthermore a list of related documents and download links thereto are provided, allowing interested parties to download these documents easily and from a centralized repository.

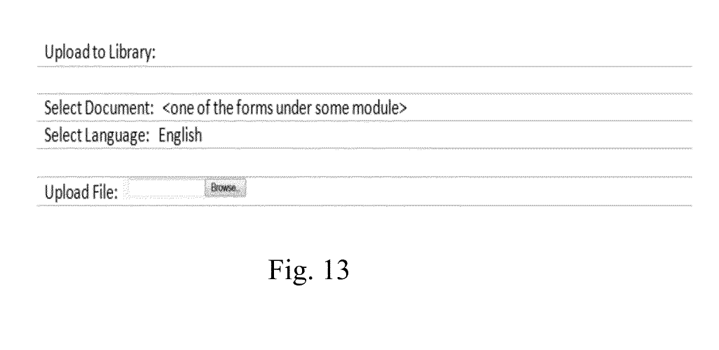

FIG. 13 presents another possible element of the UI of the system, in particular a page allowing for a user to upload a document associated with a certain application. Thus the application library name is listed as well as related information such as document name, language, and the like.

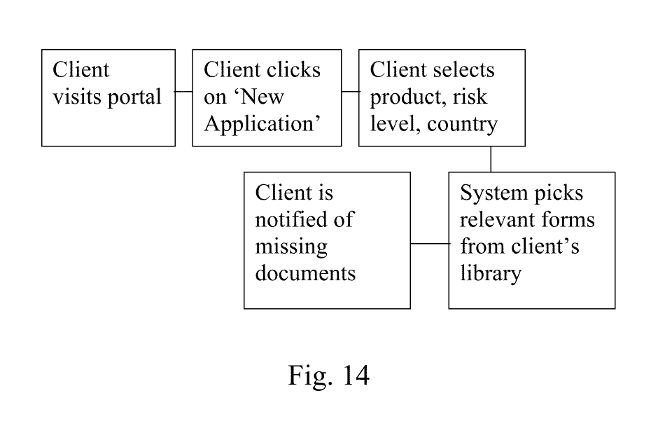

FIG. 14 presents a brief flowchart for a client applying for a new application. The client first visits the portal, selects (in this example) ‘New Application’, selects the product, risk category, and country, then picks the relevant forms from the client library. After this process has been completed, the client is notified of any missing documents (as seen in FIG. 12 where a missing document has a warning symbol next to its filename).

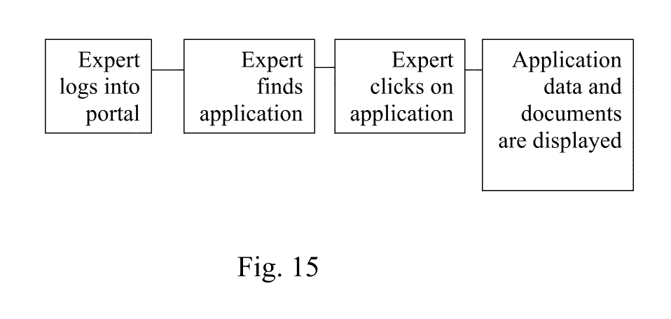

FIG. 15 presents a brief flowchart for an expert associated with the system who is desirous of viewing an application. The expert first logs into the portal, then searches for the application in question. The expert clicks on the application number, at which point the associated application data and documents are displayed.

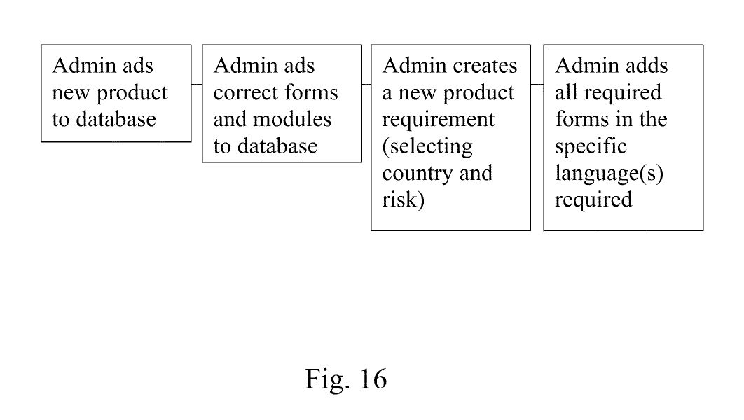

FIG. 16 presents a brief flowchart for an admin associated with the system who want to add a new product requirement to the system (for instance as may be the case when a regulatory agency introduces a new regulation to their licensing requirements). Thus the admin first adds the new product requirement to the database, then adds all the correct forms and modules to a database of the system. The admin then creates a new product requirement for a given country and risk level. The admin then adds all the forms required, in the specific language in which they are required. In this way the system may be kept up to date even in a changing landscape of ever-shifting regulatory requirements.

It is within provision of the system and method that it comprise CRM platform.

The GPCFC and UCDI may be explicated by use of the following example. Every string of options in the data base (whether a string of information from a complete application folder, or a partial string, or the like) in its current version can be coded to represent that order of specific information, as in a hash. This hash or other equivalent code can be represented for example in a bar code, or other coding system. The Regulatory file application content, and all dependent documents in the version at the time approval was granted, may be hashed in this fashion and represented by such a code. This code will include all options and parameters such as the level of expertise any given expert can have for a designated type of medical devise and there module of risks etc.

The GPCFC is delivered by computation of a hash or other function of the Product/module/compliance form/standard/country documents and parameter values. The values of computing product compliance properties based on a given set of parameters will create a generally unique hash value that will enable the system operator to cross-check, verify, and manipulate medical technology information through proprietary classification and coding systems for newly recognized hash values.

The UCDI is adapted to produce a unique hash that all users can recognize as the one that represents the information of the product at the time it achieved the licensing requirements. This status is available through the system to the authorities, who must all agree as to the integrity of the product information represented by the hash code. Thus the hash allows a unified barcode or the like (based on the hash) that may be used when labeling the product and bringing it through customs, or for other identification purposes. In the same manner, customs authorities in the USA check every device for FDA clearance before clearance; with the instant system and method, customs agents may now simply verify the barcode on the product, which for instance will link immediately to a database record, or simply fulfill a mathematical criterion required of any valid product, in a fashion similar to that already available through the barcoding of other types of information.

The system utilizes an intuitive process for data entry and perusal. For example, consider the following work flow for reaching compliance of a medical device:
Client—Chooses the “type of medical device”.
Client—Chooses the “Country(ies) for registration”.
System—Provides a list of all necessary documents for that country, or countries.
Client—Uploads relevant documents and information into the system.
System—Validates documents and information integrity, and suggests modifications.
System—Prepares the regulatory application(s).
System—Provides all complementary services.
System—Submits the regulatory application(s).
Client—Is notified when license is achieved.
System—maintains license validity and updated regulatory status.
Client—Repeat for additional markets.

The system also has provision to implement a custom solution to improve communication and collaboration between clients and experts.

The system furthermore allows clients to manage their document library very easily. It enables project managers and experts alike to access relevant client documents in a very structured way.

The proposed solution enables the following actions on the part of the corresponding actors:

### 1) System Administrators may:

a) Add new products

b) Add a new product requirement

c) Add a new country

d) Add a new module

e) Add a new form (and upload relevant documentation)

### 2) Experts may:

a) View client's application and all the relevant documents

b) Download client documents

### 3) Client may:

a) View own library (upload to library)

b) View or create new application (upload any missing documents)

In order to make accessing application documents easier for the experts, the system may comprise a custom visual interface that summarizes all the information and client documents on one screen.

As will be appreciated, there are certain experts in the various fields at hand whose expertise lies in their ability to categorize and classify. For example in the field of medical instruments there may be experts at classifying devices, which sometimes will belong to several categories depending upon the classification scheme. As may be appreciated, for purposes of determining the regulations incumbent upon a specific device, the proper classification thereof is of paramount importance. Thus amongst the pool of experts, those experts uniquely qualified to categorize and classify will be called upon, under auspices of the method, to classify devices or aid in the classification thereof when necessary, such that users will not necessarily have to perform unaided what is in some cases a highly specialized task.

For example, ECG classification of any device usually contain about 15 categories of devices, each having 3-5 sub-categories, but each sub-category may contain numerous specific compliance forms and variations (such per country, per language, per standard, per guide line etc). Hence, device planner or manufacturer cannot be sure what would be the likely regulatory requirements.

Any new device to be regulated or marketed using the current system and method may be assigned to a unique category in order to allow a more advanced categorizing system. Thus, allowing any later similar device to be categorized in said category. Hence, allowing the system to infer what appropriate and/or likely regulation that will be imposed on said new device.

Said new advanced categorizing system may be implemented by regulatory agencies in order to clarify and remove impediments from device planners and manufacturers.

As will be appreciated, the method and system apply not just to the field of regulatory compliance for medical devices, but will also be of use in various other fields such as that of therapeutic devices, pharmaceuticals, medicaments, foods, and the like as should be clear to one skilled in the art.

Although selected embodiments of the present system and method have been shown and described, it is to be understood the present system and method is not limited to the described embodiments. Instead, it is to be appreciated that changes may be made to these embodiments without departing from the principles and spirit of the system and method, the scope of which is defined by the claims and the equivalents thereof.

What is claimed is:

1. A regulatory compliance tool for users seeking to achieve licenses for devices to be licensed by regulatory agencies comprising:
a. a database of regulations concerning a plurality of devices and countries;
b. a database of experts having expertise in matters of regulatory compliance;
c. a database of regulatory compliance documents;
d. an expert system adapted to guide said users along a regulatory compliance route informed by said database of regulations;
e. a server adapted to store said databases and provide communications between said databases, said users, said experts, said expert system, and said agencies;
whereby users can upload and peruse said regulatory compliance documents, experts may review and revise said compliance documents, and regulatory agencies may evaluate said compliance documents, thus implementing a unified compliance tool adapted for use worldwide.

2. The compliance tool of claim 1 wherein said devices are selected from the group consisting of: medical devices, therapeutic devices, pharmaceuticals, medicaments, foods.

3. The compliance tool of claim 1 further implementing a barcode derived from a hash of said compliance documents at the time of licensing by said regulatory agencies, said barcode adapted to identify said devices to be licensed.

4. The compliance tool of claim 1 wherein said database of regulations comprises continuously updated information regarding regulatory requirements, procedures, and information for each of said devices in each of said countries.

5. The compliance tool of claim 1 wherein said database of experts comprises continuously updated information concerning said experts' domain of expertise, experience, rating, and record.

6. The compliance tool of claim 1 wherein said experts review and edit said regulatory compliance documents.

7. The compliance tool of claim 1 wherein said database of regulatory compliance documents is adapted to be read, written to, and modified by said users, said experts, and said agencies according to a set of permissions determined by said users.

8. The compliance tool of claim 1 wherein said expert system is adapted to assess necessary elements required for said devices to be licensed, and further adapted to guide said users through the process of generating said necessary elements.

9. The compliance tool of claim 1 wherein said expert system is adapted to determine available untapped markets using parameters selected from the group consisting of: budget, market size, compliance difficulty, compliance documents already obtained, compliance documents not yet obtained.

10. The compliance tool of claim 1 wherein said server is maintained by system administrators by means of software adapted to allow said system administrators to perform actions upon said databases selected from the group consisting of: adding new devices; adding new device requirements; adding new countries; adding new modules; adding new forms.

11. The compliance tool of claim 1 wherein said databases are rendered easily navigable by means of presenting information contained therein upon a single computer screen.

12. The compliance tool of claim 1 wherein said server is adapted to submit and maintain regulatory applications automatically.

13. A method for achieving regulatory compliance for users' devices to be licensed by regulatory agencies comprising steps of:
a. providing a database of regulations concerning a plurality of devices and countries;
b. providing a database of experts having expertise in matters of regulatory compliance;
c. providing a database of regulatory compliance documents;
d. providing expert system adapted to guide said users along a regulatory compliance route informed by said database of regulations;
e. providing a server adapted to store said databases and provide communications between said databases, said users, said experts, said expert system, and said agencies;
whereby users can follow a stored regulatory compliance route by uploading regulatory compliance documents, experts reviewing and revising said compliance documents, and regulatory agencies evaluating said compliance documents, thus implementing a unified compliance tool adapted for use worldwide.

14. The method of claim 13 wherein said devices are selected from the group consisting of: medical devices, therapeutic devices, pharmaceuticals, medicaments, foods.

15. The method of claim 13 further implementing a barcode derived from a hash of said compliance documents at the time of licensing by said regulatory agencies, said barcode adapted to identify said devices to be licensed.

16. The method of claim 13 wherein said database of regulations comprises continuously updated information regarding regulatory requirements, procedures, and information for each of said devices in each of said countries.

17. The method of claim 13 wherein said database of experts comprises continuously updated information concerning said experts' domain of expertise, experience, rating, and record.

18. The method of claim 13 wherein said experts review and edit said regulatory compliance documents.

19. The method of claim 13 wherein said database of regulatory compliance documents is adapted to be read, written to, and modified by said users, said experts, and said agencies according to a set of permissions determined by said users.

20. The method of claim 13 wherein said expert system is adapted to assess necessary elements required for said devices to be licensed, and further adapted to guide said users through the process of generating said necessary elements.

21. The method of claim 13 wherein said server is maintained by system administrators by means of software adapted to allow said system administrators to perform actions upon said databases selected from the group consisting of: adding new devices; adding new device requirements; adding new countries; adding new modules; adding new forms.

22. The method of claim 13 wherein said databases are rendered easily navigable by means of presenting information contained therein upon a single computer screen.

23. The method of claim 13 wherein said server is adapted to submit and maintain regulatory applications automatically.

24. The method of claim 13 wherein said expert system is adapted to determine available untapped markets using parameters selected from the group consisting of: budget, market size, compliance difficulty, compliance documents already obtained, compliance documents not yet obtained.
